(19) United States
(12) Patent Application Publication
(10) Pub. No.: US 2026/0027841 A1
(43) Pub. Date: Jan. 29, 2026

(54) LIQUID EJECTION APPARATUS

(71) Applicant: SEIKO EPSON CORPORATION, Tokyo (JP)

(72) Inventors: Yuki HARA, SHIOJIRI-SHI (JP); Masaki SHIMOMURA, MATSUMOTO-SHI (JP); Shintaro KOMURO, MATSUMOTO-SHI (JP); Koji HARA, MATSUMOTO-SHI (JP); Hiroshi SHIOBARA, MATSUMOTO-SHI (JP); Koki MURAKAMI, AGEMATSU-MACHI (JP); Masato OGAWA, SHIOJIRI-SHI (JP); Hiroyuki MAEDA, MATSUMOTO-SHI (JP)

(21) Appl. No.: 19/280,781

(22) Filed: Jul. 25, 2025

(30) Foreign Application Priority Data
Jul. 26, 2024 (JP) 2024-120942

(51) Int. Cl. B41J 11/00; B41J 29/17

(52) U.S. Cl. CPC B41J 11/0015; B41J 11/007; B41J 29/17

(57) ABSTRACT

A liquid ejection apparatus includes a liquid ejection unit that ejects a liquid onto a medium, a transport belt that has an attracting surface that attracts the medium and transports the medium to a position facing the liquid ejection unit, a charging unit that charges the attracting surface with a first polarity, and a control unit that controls the transport belt and the charging unit, wherein the attracting surface has a transport region that comes into contact with the medium to be transported and a non-transport region provided between the transport regions, and the control unit causes the charging unit to charge at least a part of the transport region of the attracting surface with the first polarity and not to charge the non-transport region of the attracting surface with the first polarity.

The present application is based on, and claims priority from JP Application Serial Number 2024-120942, filed Jul. 26, 2024, the disclosure of which is hereby incorporated by reference herein in its entirety.

### BACKGROUND

### 1. Technical Field

The present disclosure relates to a liquid ejection apparatus.

### 2. Related Art

In related art, as disclosed in JP-A-2003-103857, an inkjet recording apparatus is known as a liquid ejection apparatus that attracts a recording sheet to a transport belt by alternately charging the transport belt with positive and negative charges.

JP-A-2003-103857 is an example of the related art.

However, in the liquid ejection apparatus described above, there is a concern that a foreign material such as paper dust may adhere to the head and cause a problem.

### SUMMARY

A liquid ejection apparatus includes a liquid ejection unit that ejects a liquid onto a medium, a transport belt that has an attracting surface that attracts the medium and transports the medium to a position facing the liquid ejection unit, a charging unit that charges the attracting surface with a first polarity, and a control unit that controls the transport belt and the charging unit, wherein the attracting surface has a transport region that comes into contact with the medium to be transported and a non-transport region provided between the transport regions, and the control unit causes the charging unit to charge at least a part of the transport region of the attracting surface with the first polarity and not to charge the non-transport region of the attracting surface with the first polarity.

### BRIEF DESCRIPTION OF THE DRAWINGS

FIG. 1 is a cross-sectional view illustrating a configuration of a liquid ejection apparatus.

FIG. 2 is a schematic diagram showing a state of charging in a supporting unit.

FIG. 3 is a schematic diagram showing a state in which part of the charge is removed from the supporting unit.

### DESCRIPTION OF EMBODIMENTS

A liquid ejection apparatus 1 will be described with reference to the drawings. Note that directions in the drawings are explained using a three-dimensional coordinate system. For convenience of explanation, a positive direction of a Z axis is referred to as an upward direction, an upside, or simply as upper, a negative direction of the Z axis is referred to as a downward direction, a downside, or simply as lower, a positive direction of an X axis is referred to as a rightward direction, a right side, or simply as right, a negative direction of the X axis is referred to as a leftward direction, a left side, or simply as left, a positive direction of a Y axis is referred to as a forward direction, a front side, or simply as front, and a negative direction of the Y axis is referred to as a rearward direction, a rear side, or simply as rear.

### 1. Configuration of Liquid Ejection Apparatus

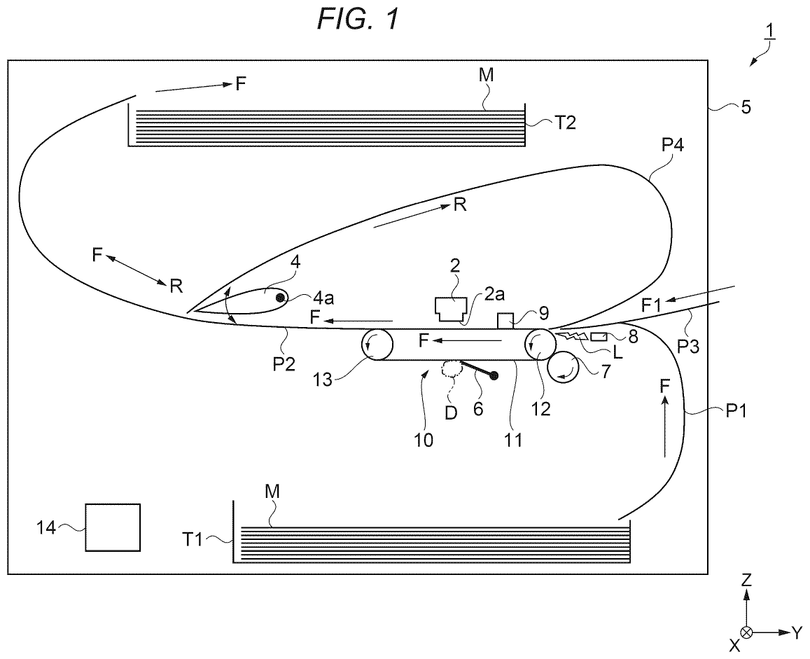

As illustrated in FIG. 1, the liquid ejection apparatus 1 includes a head 2 as a liquid ejection unit. The head 2 is, for example, a linear inkjet head extending in the left-right direction.

The head 2 performs recording by ejecting an ink as a liquid from a liquid ejection surface 2a above onto a medium M supported from underneath by a supporting unit 10. Hereinafter, the liquid ejection surface 2a is simply referred to as an ejection surface 2a.

The liquid ejection apparatus 1 includes a plurality of paths for transporting the medium M. For convenience of illustration, in FIG. 1, the medium M transported in the each path is omitted.

The liquid ejection apparatus 1 includes one path for the medium M, which extends along a transport direction F of the medium M. In the liquid ejection apparatus 1, a sheet feeding tray T1 as a sheet feeding unit, a first path P1, the head 2, the supporting unit 10 facing the head 2, a second path P2, and a sheet ejection tray T2 as a sheet ejection unit are disposed from upstream to downstream in the transport direction F of the path.

When the medium M is transported in the transport direction F and reaches a part between the head 2 and the supporting unit 10, recording is performed on the front surface as one surface of the medium by the head 2.

The liquid ejection apparatus 1 also includes a third path P3 as another path for the medium M for feeding the medium M from the front of a case 5 in a manual feed direction F1. An operator inserts the medium M into the third path P3 in the manual feed direction F1. The third path P3 communicates with the first path P1. After the medium M is transported from the third path P3 to the first path P1, the medium Mis transported in the above described transport direction F.

A branch section 4 is disposed halfway in the second path P2. The branch section 4 is rotatable around a branch shaft 4a. The branch section 4 rotates clockwise around the branch shaft 4a in advance. The branch section 4 that has rotated clockwise enables the medium M, which has been recorded on the front side, to smoothly pass through the branch section 4 of the second path P2 from the leading end in the transport direction F.

When the trailing end of the medium M transported along the second path P2 passes through the branch section 4, the transport of the medium M is temporarily stopped. The branch section 4 rotates counterclockwise around the branch shaft 4a.

In this state, when the medium M is transported in a reverse direction R as a direction opposite to the transport direction F, the medium Mis guided by the branch section 4 from the trailing end and is transported along a fourth path P4 that branches upward from the second path P2. The liquid ejection apparatus 1 may include a switchback path parallel to the second path P2 and transport the medium M in the reverse direction R.

The fourth path P4 is curved and communicates with the first path P1 below. The medium M transported from the fourth path P4 to the first path P1 is reversed. Thereafter, the medium M is transported in the above described transport direction F. The medium Mis recorded on a back side as the other side by the head 2. As described above, the medium M can be recorded on both sides, with the front surface being recorded first, then reversed and recorded on the back surface.

A plurality of transport rollers (not illustrated) are respectively provided in the first path P1, the second path P2, the third path P3, and the fourth path P4 to enable the medium M to be transported.

The supporting unit 10 includes a belt 11 as a transport belt, a first roller 12, and a second roller 13.

The supporting unit 10 also includes, for example, a roller motor (not illustrated) that rotates the first roller 12. In this case, the first roller 12 is a driving roller driven by the roller motor and the second roller 13 is a driven roller that rotates in conjunction with the first roller 12.

The supporting unit 10 rotates the first roller 12 and the second roller 13 by the roller motor. The belt 11 as an endless belt is looped around the first roller 12 and the second roller 13 to circulate around them. The first roller 12 and the second roller 13 rotate counterclockwise and the belt 11 circulate counterclockwise, and thus the supporting unit 10 can transport the medium M on the belt 11 along the transport direction F from the front to the rear.

The belt 11 transports the medium M to a position facing the head 2, and the head 2 can eject an ink onto the medium M for recording.

Further, the supporting unit 10 includes a charging unit, a discharging brush 9, and a blade 6. The charging unit includes a charging roller 7 that can charge the belt 11 and a laser 8 as a light irradiation unit that can irradiate with the laser beam L. These component elements of the supporting unit 10 will be described in detail later.

The liquid ejection apparatus 1 includes a control unit 14 mounted on a control board (not illustrated). The control unit 14 performs integrated control of the respective units of the liquid ejection apparatus 1. The control unit 14 includes a central processing unit (CPU). The CPU is also referred to as a processor.

The control unit 14 includes memories such as a flash read only memory (ROM) as a rewritable nonvolatile memory, and a random access memory (RAM) as a volatile memory.

The control unit 14 reads a program stored in the flash ROM and executes various kinds of processing using the RAM as a work area. Specifically, the control unit 14 can control the head 2 to eject the ink, and control motors of the respective units of the liquid ejection apparatus 1 and actuators of the laser 8 and the like.

### 2. Charging in Supporting Unit

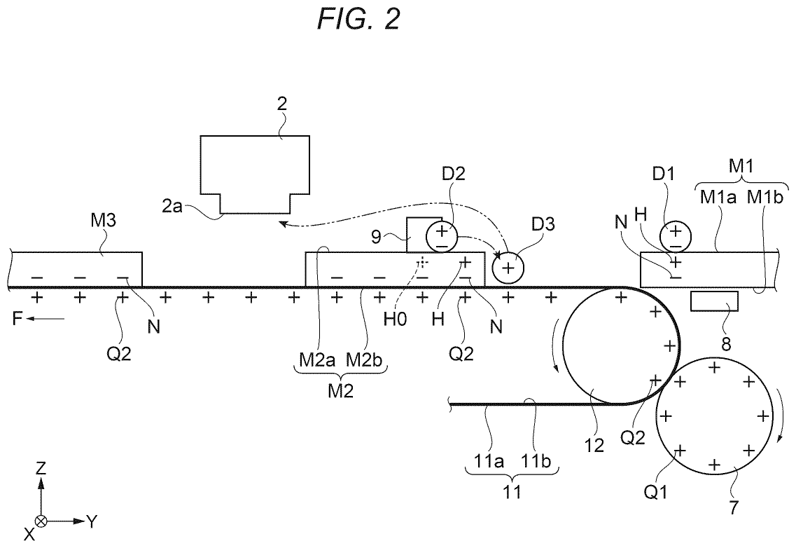

First, with reference to FIG. 2, in the supporting unit 10, the respective states of charge transition including charging of the belt 11 by the charging roller 7, polarization of each of a first medium M1, a second medium M2, and a third medium M3, and discharge by the discharging brush 9 will be described. FIG. 2 shows a case where the laser 8 does not irradiate an outer circumferential surface 11a of the belt 11 with the laser beam L.

Further, FIG. 2 also illustrates charge transition including polarization and discharge of each of a first foreign material D1, a second foreign material D2, and a third foreign material D3. Hereinafter, the first medium M1, the second medium M2, and the third medium M3 are simply referred to as the medium M.

Under control of the control unit 14, as illustrated in FIG. 2, in the supporting unit 10, the first roller 12 circulate counterclockwise, comes into contact with an inner peripheral surface 11b of the belt 11, and causes the belt 11 to rotate counterclockwise. The charging roller 7 is driven by the first roller 12 and rotates clockwise with the belt 11 in between together with the first roller 12. The medium M is placed on the outer circumferential surface 11a of the belt 11 and transported along the transport direction F by the supporting unit 10.

In the example of FIG. 2, a plurality of media M including at least the leading end of the first medium M1, the second medium M2, and the third medium M3 are placed on the outer circumferential surface 11a of the belt 11 and transported in the transport direction F. As described above, FIG. 2 illustrates a state in which, when the leading end of the first medium M1 is placed on the belt 11, the second medium M2 and the third medium M3 different from the first medium M1 are transported downstream.

As will be described later, the outer circumferential surface 11a of the belt 11 is also an attracting surface that attracts these media M. Hereinafter, the outer circumferential surface 11a of the belt 11 is simply referred to as the belt 11.

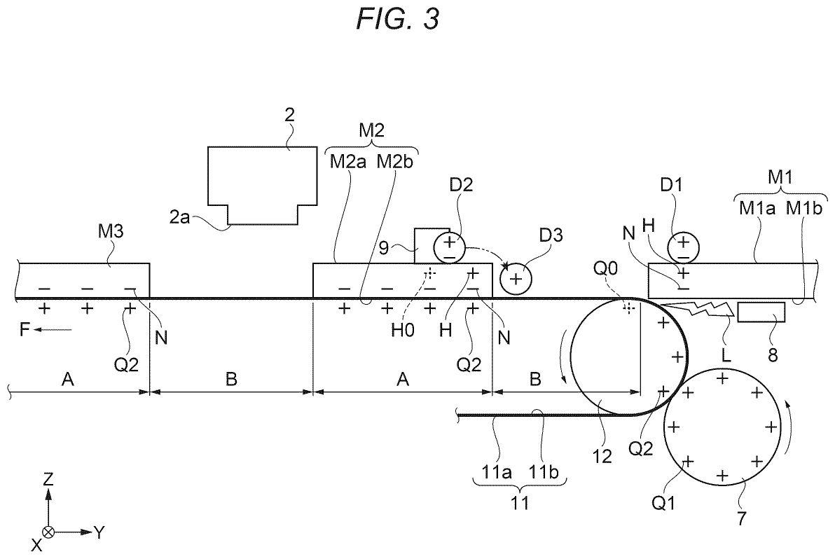

FIG. 2 can also be described as illustrating a state in which, as the same first medium M1 is transported by the belt 11 along the transport direction F, the positions transition as the first medium M1, the second medium M2, and the third medium M3 in order from the upstream. For convenience, in FIG. 2, the following description will be made assuming that the position of the first medium M1 transitions as described above. The first foreign material D1 to the third foreign material D3 to be described later will be described in the same manner. The same applies to the case in FIG. 3 to be described later.

While being circulated by the first roller 12, the belt 11 comes into contact with the outer circumference of the charging roller 7 rotating clockwise on the front lower side of the supporting unit 10. The charging unit includes the charging roller 7, a DC power supply (not shown), and the laser 8.

The charging roller 7 is formed using conductive rubber. Under control of the control unit 14, for example, a positive voltage having a positive polarity as a first polarity is applied to the outer circumference of the charging roller 7 by the DC power supply, and a first charge Q1 as a positive charge having the first polarity is charged. A second polarity is a negative polarity.

The first charge Q1 is transferred to the outer circumferential surface 11a of the circulating belt 11 of the supporting unit 10 in order from a portion in contact with the rotating charging roller 7, and is charged as the second charge Q2 as the positive charge. In this manner, the charging roller 7 provided in the charging unit can charge the outer circumferential surface 11a of the belt 11 with the second charge Q2 having the first polarity.

The inner circumferential surface 11b of the belt 11 is formed using, for example, conductive polyimide as a conductive material and is electrically grounded. The outer circumferential surface 11a of the belt 11 is formed using, for example, a thermoplastic resin such as ETFE as an insulating material. That is, the attracting surface as the outer circumferential surface 11a of the belt 11 is formed of an insulating layer.

The belt 11 having the configuration has a property that the outer circumferential surface 11a is easily charged with the second charge Q2. Specifically, the outer circumferential surface 11a of the belt 11 is dielectrically charged with the second charge Q2 by the first charge Q1 of the charging roller 7.

In practice, the outer circumferential surface 11a of the belt 11 is charged with the second charge Q2, however, for convenience of illustration, FIG. 2 shows that the inner peripheral surface 11b of the belt 11 is charged with the second charge Q2. The same applies to the case in FIG. 3.

The first medium M1 is placed in contact with the belt 11 from the leading end along the transport direction F. The first medium M1 is induced by the second charge Q2 charged on the belt 11 and is polarized inside. Specifically, in the first medium M1, a positive charge H is generated at the side of a first front surface M1a and a negative charge N is generated at the side of a first back surface M1b in order from the leading end in contact with the belt 11. The first foreign material D1 such as paper dust adhering to the first front surface M1a of the first medium M1 is also induced with the polarization of the first medium M1 and is polarized inside.

Note that, in FIG. 2, the laser 8 does not irradiate the belt 11 with the laser beam L, and thus the second charge Q2 of the belt 11 is not removed unlike that in FIG. 3 to be described later. In FIG. 2, the second charge Q2 charged on the outer circumferential surface 11a of the belt 11 is maintained along the transport direction F.

The discharging brush 9 above the belt 11 is formed using a conductive metal brush, a conductive fiber, or the like, and is electrically grounded.

The first medium M1 is transported downstream in the transport direction F and reaches a position facing the head 2. As illustrated in FIG. 2, the first medium M1 that has reached the position is referred to as the second medium M2. The second medium M2 is transported by the belt 11 with a second front surface M2a in contact with the discharging brush 9 above.

The positive charge H polarized to the second front surface M2a side of the second medium M2 is removed by the grounded discharging brush 9. The removal of the charge is also referred to as discharging. The positive charge H to be removed is indicated as a second removed charge H0. On the other hand, the negative charge N polarized to the second back surface M2b side of the second medium M2 not in contact with the discharging brush 9 remains.

The negative charge N remaining at the second back surface M2b side of the second medium M2 is attracted to the second charge Q2 as the positive charge charged on the belt 11. That is, the second back surface M2b of the second medium M2 is attracted to the outer circumferential surface 11a of the belt 11 by the electrostatic force as a Coulomb force. As a result, the second medium M2 is attracted to the belt 11.

As described above, the charged belt 11 can attract the medium M by the electrostatic force, and can transport the second medium M2 with high accuracy. The belt 11 is also referred to as an electrostatic attracting belt, and the outer circumferential surface 11a of the belt 11 is also referred to as an attracting surface.

The distance between the second medium M2 attracted to the belt 11 and the ejection surface 2a of the head 2 can be constant. In this state, the ink is ejected from the ejection surface 2a of the head 2, and thus the ink can land on the second medium M2 with high accuracy and the recording quality can be improved.

The second medium M2 recorded by the head 2 is continuously attracted to the second charge Q2 of the belt 11 by the negative charge N on the second back surface M2b side, and attracted to the belt 11 and transported.

The second medium M2 is transported downstream in the transport direction F and reaches a position not facing the head 2. As illustrated in FIG. 2, the second medium M2 that has reached this position is referred to as the third medium M3. Subsequently, also in the third medium M3, the remaining negative charge Nis attracted to the second charge Q2 of the belt 11. The third medium M3 is also attracted to the belt 11 and transported.

The first foreign material D1 adhering to the first medium M1 is transported together with the first medium M1, and reaches a position where the material is referred to as the second foreign material D2 adhering to the second medium M2 as illustrated in FIG. 2.

While being transported together with the second medium M2 by the belt 11, the second foreign material D2 adhering to the second medium M2 comes into contact with the discharging brush 9 above. The second foreign material D2 is swept out by the discharging brush 9. The swept second foreign material D2 is referred to as the third foreign material D3. The third foreign material D3 tends to fall falls between the first medium M1 and the second medium M2 on the belt 11.

As described above, the second removed charge H0 as the positive charge H on the second front surface M2a side of the second medium M2 is removed by the discharging brush 9. Concurrently, the neutralizing brush 9 removes the second removed charge H0 as the positive charge of the second medium M2 and removes the negative charge of the polarized second foreign material D2. As a result, the third foreign material D3 has only the positive charge.

As described above, the third foreign material D3 having only the positive charge tends to fall on the belt 11. However, the belt 11 is charged with the positive second charge Q2 having the same first polarity as the third foreign material D3. An electrostatic force acts on the positively charged third foreign material D3 so as to repel the second charge Q2 as the positive charge having the same first polarity charged on the belt 11, and the third foreign material floats upward.

Meanwhile, around the third foreign material D3, an air flow in the transport direction F is generated by the belt 11, the medium M, and the like transported in the transport direction F. The third foreign material D3 floating upward may float toward the head 2 located in the transport direction F due to the air flow. Therefore, the third foreign material D3 may adhere to the ejection surface 2a of the head 2, which may cause a problem such as an ink ejection failure.

In FIG. 2, the positive voltage having the positive polarity as the first polarity is applied to the charging roller 7 by the DC power supply, and the first charge Q1 as the positive charge is charged. By switching the polarity of the voltage applied by the DC power supply, the negative voltage having the negative polarity as the second polarity can be applied to the charging roller 7.

In this case, the charging roller 7 is charged with the negative charge corresponding to the first charge Q1, and the respective portions shown in FIG. 2 are charged so as to have opposite polarities. Although the polarity is different from that in FIG. 2, the second medium M2 can be attracted to the belt 11 like that in FIG. 2.

### 3. Removal of Partial Charge from Supporting Unit

Next, a case where the laser 8 irradiates the outer circumferential surface 11a of the belt 11 with the laser beam L will be described with reference to FIG. 3. FIG. 3 shows charge transition when the charged belt 11 is irradiated with the laser beam L by the laser 8, thereby removing partial charge compared with FIG. 2.

In the description of FIG. 3, the same component elements as those in FIG. 2 described above have the same signs and part of the overlapping description with that of FIG. 2 will be omitted.

In FIG. 3, as is the case in FIG. 2 described above, the first charge Q1 as the positive charge is charged on the outer circumference of the charging roller 7. The first charge Q1 is sequentially transferred to the outer circumferential surface 11a of the circulating belt 11 in order from a portion in contact with the rotating charging roller 7, and is charged as the second charge Q2 as the positive charge.

In the transport direction F of the belt 11, a region where the belt 11 is not irradiated with the laser beam L by the laser 8 is formed under control of the control unit 14. This region is referred to as a region A. The region A is a region where a state in which the second charge Q2 is charged in the belt 11 is maintained.

Further, the region A is a region where the medium M including the first medium M1, the second medium M2, and the third medium M3 is placed on the belt 11. The region A can also be referred to as a transport region in contact with the medium M for transporting the medium M in the belt 11.

On the other hand, in the transport direction F of the belt 11, a region where the belt 11 is irradiated with the laser beam L by the laser 8 is formed under control of the control unit 14. This region is referred to as a region B. The region B is a region where the charged second charge Q2 has been removed by the laser beam L, i.e., a region not charged in the belt 11. The second charge Q2 to be removed by the laser 8 is indicated as a first removed charge Q0.

Further, the region B is a region where the medium M including the first medium M1, the second medium M2, and the third medium M3 is not placed in the belt 11. The region B may be referred to as a non-transport region not in contact with the medium M or not for transporting the medium M in the belt 11.

Furthermore the region B is a region between the respective media M in the belt 11. The region B is also a non-transport region provided between the transport regions as the regions A.

As described above, under control of the control unit 14, the charging unit including the charging roller 7 and the laser 8 can charge at least a part of the region A as the transport region of the belt 11 with the positive charge having the first polarity.

On the other hand, under control of the control unit 14, the charging unit including the charging roller 7 and the laser 8 can remove the positive charge of the region B as the non-transport region of the belt 11 to suppress the region B from being charged.

Note that, under control of the control unit 14, the laser 8 may also irradiate a region of the belt 11 located closer to an end portion than the center portion of the medium M in the transport direction F with the laser beam L to remove the positive second charge Q2 having the first polarity.

As a result, the belt 11 in contact with the region located at the end portion of the medium M in the front-rear direction can be prevented from being charged with the second charge Q2.

That is, the region B may be a region including the end portion of the medium M. The generation of the electrostatic force due to the second charge Q2 of the belt 11 with respect to the third foreign material D3, which will be described later can be suppressed more effectively.

In this case, the region A is a region located in the center portion of the medium M excluding the end portion and charged with the positive second charge Q2 having the first polarity. In each center portion of the second medium M2 and the third medium M3, the negative charge N is attracted to the second charge Q2 of the belt 11 and each medium can be attracted to the belt 11.

Due to the second charge Q2 charged on the belt 11, the first medium M1 is polarized into the positive charge H on the first front surface M1a side and the negative charge N on the first back surface M1b side in order from the leading end in contact with the belt 11. The first foreign material D1 adhering to the first front surface M1a of the first medium M1 is similarly polarized.

When the first medium M1 is transported and reaches the position of the second medium M2, the second front surface M2a comes into contact with the discharging brush 9, and the positive charge H on the second front surface M2a side is removed. The positive charge H to be removed is indicated as a second removed charge H0. On the other hand, the negative charge N on the second back surface M2b side remains.

The negative charge N of the second medium M2 is attracted to the second charge Q2 of the belt 11, and the second medium M2 is attracted to the belt 11.

The first foreign material D1 is transported together with the first medium M1 and reaches the position of the second foreign material D2 adhering to the second medium M2. The second foreign material D2 is swept out by the discharging brush 9 and falls as the third foreign material D3 into the position of the region B between the first medium M1 and the second medium M2 on the belt 11.

In this regard, since the negative charge of the polarized second foreign material D2 is removed by the discharging brush 9, the third foreign material D3 as the swept out second foreign material D2 has only the positive charge.

Here, unlike FIG. 2, in FIG. 3, the second charge Q2 has been removed by the laser 8 in the region B of the belt 11. The third foreign material D3 falls into the uncharged region B of the belt 11.

Although the third foreign material D3 has only the positive charge, there is no second charge Q2 in the region B of the belt 11 into which the third foreign material D3 falls. Therefore, the electrostatic force due to the second charge Q2 is not generated in the third foreign material D3. The third foreign material D3 is suppressed from floating upward by the electrostatic force. As a result, adhesion of the third foreign material D3 to the ejection surface 2a of the head 2 is suppressed, and occurrence of a failure is suppressed.

The third foreign material D3 is swept out by the discharging brush 9 and falls onto the belt 11 between the first medium M1 and the second medium M2. The third foreign material D3 placed on the circulating belt 11 is transported. Then, as shown in FIG. 1, the third foreign material D3 is scraped off as the foreign material D by the blade 6 and removed from the belt 11.

### 4. Other Embodiments

As described above with reference to FIG. 3, the positive voltage having the positive polarity as the first polarity is applied to the charging roller 7 by the DC power supply, and the first charge Q1 as the positive charge is charged. Hereinafter, several examples of other embodiments with respect to FIG. 3 will be described.

As another embodiment, the polarity of the voltage applied by the DC power supply may be switched and a negative voltage having a negative polarity as the second polarity may be applied to the charging roller 7 to charge a negative charge corresponding to the first charge Q1. Also in this case, though different in polarity, as is the case of FIG. 3, the charge is removed from the region B of the belt 11 into which the third foreign material D3 falls, thereby suppressing the upward floating of the third foreign material D3.

In the above described manner, the polarity of the applied voltage of the DC power supply can be switched. As shown in FIG. 3, the charging roller 7 can be positively charged or negatively charged.

As another embodiment, a positive voltage having a first polarity and a negative voltage having a second polarity may be alternately applied to the outer circumference of the charging roller 7 by an AC power supply (not shown). The polarity of the voltage applied to the charging roller 7 is switched by the AC power supply. The applied voltage may have rectangular waves.

The charging roller 7 is alternately charged with a positive first charge Q1 and a negative charge having the same value as the first charge Q1. In this case, under control of the controller 14, the region A of the belt 11 of the supporting unit 10 can be charged with the second charge Q2, and the region B can be charged with a negative charge having the same value as the second charge Q2. Similarly to FIG. 3, the first medium M1, the first foreign material D1, and the like are polarized.

In this case, in the region A of the belt 11, as is the case of FIG. 3, the second medium M2 comes into contact with the discharging brush 9 and the positive charge H is removed, and the negative charge N is attracted onto the second charge Q2 of the belt 11.

On the other hand, the region B of the belt 11 into which the third foreign material D3 having only the positive charge falls is charged with a negative charge having the same value as the second charge Q2. The positively charged third foreign material D3 is attracted to the belt 11 in the negatively charged region B by an electrostatic force.

Since the third foreign material D3 is suppressed from floating upward without using the laser 8, the third foreign material is prevented from adhering to the ejection surface 2a of the head 2 and causing a problem.

As another embodiment, a positive voltage having the first polarity and a ground voltage having no polarity may be alternately applied to the outer circumference of the charging roller 7 by an AC power supply that switches the applied voltage. The polarity of the applied voltage including non-polarity is switched by the AC power supply. The applied voltage may have rectangular waves.

In the charging roller 7, a region with the positive first charge Q1 and a nonpolar region not charged alternately appear. In this case, under control of the control unit 14, the region A of the belt 11 of the supporting unit 10 can be charged with the second charge Q2, and the region B can be set as a nonpolar region not charged. Here, each portion can be charged in the same state as in FIG. 3 without using the laser 8.

Alternatively, a negative voltage having the second polarity and a nonpolar ground voltage may be alternately applied to the outer circumference of the charging roller 7 by an AC power supply.

Alternatively, a positive voltage having the first polarity and a negative voltage having the second polarity may be alternately applied to the outer circumference of the charging roller 7 by an AC power supply. In this case, the belt 11 in the region B is negatively charged, and the positively charged third foreign material D3 is attracted by the electrostatic force.

As described above, the liquid ejection apparatus 1 includes the head 2 as a liquid ejection unit that ejects an ink as a liquid onto the medium M, the belt 11 having the outer circumferential surface 11a as an attracting surface that attracts the medium M and transporting the medium M to a position facing the head 2, the charging unit that charges the outer circumferential surface 11a with the positive polarity as the first polarity, and the control unit 14 that controls the belt 11 and the charging unit. The charging unit includes the charging roller 7 and the laser 8.

The outer circumferential surface 11a of the belt 11 has the region A as a transport region in contact with the medium M to be transported and the region B as a non-transport region provided between the regions A.

The control unit 14 causes the charging unit to charge at least a part of the region A of the outer circumferential surface 11a of the belt 11 with the first polarity and not to charge the region B with the first polarity.

In the liquid ejection apparatus 1 having the configuration, as illustrated in FIG. 3, for example, the negative charge N of the second medium M2 is attracted to the second charge Q2 of the belt 11, and the second medium M2 can be attracted to the belt 11 and transported.

Further, the second foreign material D2 adhering to the second medium M2 is swept out by the discharging brush 9 and falls into the region B of the belt 11 as the third foreign material D3 having only the positive charge.

At this time, since the region B of the belt 11 is not charged, the third foreign material D3 is suppressed from floating upward due to the electrostatic force and adhering to the head 2, thereby preventing the occurrence of a failure.

Although the embodiments have been described in detail with reference to the drawings, the specific configurations are not limited to the embodiments, and may be changed, replaced, or deleted without departing from the gist of the disclosure.

In the above description, the second charge Q2 charged on the belt 11 is removed by the laser 8. An ultraviolet irradiator may be provided as the light irradiation unit, and the charge may be removed by irradiation with ultraviolet rays.

Alternatively, the second charge Q2 may be removed by an ionizer. In this case, the ionizer can generate negative ions and neutralize and remove the second charge Q2 as the positive charge.

In the above description, the head 2 is explained as an example of the linear inkjet head, but may be a serial ink jet head mounted on a carriage.

What is claimed is:

1. A liquid ejection apparatus comprising:
a liquid ejection unit that ejects a liquid onto a medium;
a transport belt that has an attracting surface that attracts the medium and transports the medium to a position facing the liquid ejection unit;
a charging unit that charges the attracting surface with a first polarity; and
a control unit that controls the transport belt and the charging unit, wherein
the attracting surface has a transport region that comes into contact with the medium to be transported and a non-transport region provided between the transport regions, and
the control unit causes the charging unit to charge at least a part of the transport region of the attracting surface with the first polarity and not to charge the non-transport region of the attracting surface with the first polarity.

2. The liquid ejection apparatus according to claim 1, wherein
the control unit causes the charging unit to charge the attracting surface in contact with a region located at a center portion of the medium with the first polarity, and not to charge the attracting surface in contact with a region located closer to an end portion of the medium than the center portion with the first polarity.

3. The liquid ejection apparatus according to claim 1, wherein
the first polarity is a positive polarity, and
the control unit is capable of positively charging the attracting surface by the charging unit and removing the charge from the non-transport region of the attracting surface.

4. The liquid ejection apparatus according to claim 3, wherein
the attracting surface is formed of an insulating layer.

5. The liquid ejection apparatus according to claim 1, wherein
the charging unit includes a charging roller for positively or negatively charging by switching an applied voltage.

6. The liquid ejection apparatus according to claim 5, wherein
the first polarity is a positive polarity, and
the control unit causes the charging unit to negatively charge the non-transport region of the attracting surface.

7. The liquid ejection apparatus according to claim 1, wherein
the charging unit includes a charging roller.

8. The liquid ejection apparatus according to claim 1, wherein
the charging unit includes a charging roller and a light irradiation unit configured to discharge the transport belt.

9. The liquid ejection apparatus according to claim 1, further comprising a discharging brush that comes into contact with the medium.
